(19) United States
(12) Patent Application Publication
(10) Pub. No.: US 2025/0298884 A1
(43) Pub. Date: Sep. 25, 2025

(54) IDENTITY AUTHENTICATION METHOD, APPARATUS, DEVICE, MEDIUM AND PRODUCT

(71) Applicant: Beijing Zitiao Network Technology Co., Ltd., Beijing (CN)

(72) Inventors: Xin TAO, Beijing (CN); Hailong LI, Beijing (CN); Yujie HUANG, Beijing (CN); Yinfeng ZHENG, Beijing (CN)

(21) Appl. No.: 18/863,609

(22) PCT Filed: Jun. 5, 2023
(86) PCT No.: PCT/CN2023/098252

§ 371 Date: Nov. 6, 2024

(30) Foreign Application Priority Data
Jun. 24, 2022 (CN) 202210724387.X

(51) Int. Cl. G06F 21/41

(52) U.S. Cl. CPC G06F 21/41

(57) ABSTRACT

The present disclosure relates to the technical field of computers. Provided in the present disclosure are an identity authentication method and apparatus, a device, a medium and a product. The method includes: acquiring a pre-configured first field of a first platform and a pre-configured second field of a second platform; receiving a first field value of the first field sent by the first platform, the first field value being obtained after a first account passes identity authentication on the first platform; determining a binding result of the first account according to the first field value; and if the binding result of the first account represents that there is a second field value in the second field that is bound with the first field value, passing identity authentication of a second account corresponding to the second field value.

### CROSS-REFERENCE TO RELATED APPLICATIONS

This application is a U.S. National Stage under 35 U.S.C. § 371 of International Application No. PCT/CN2023/098252, as filed on Jun. 5, 2023, which is based on and claims the priority of Chinese patent application with application No. 202210724387.X, filed on Jun. 24, 2022 to the State Intellectual Property Office of China, titled “IDENTITY AUTHENTICATION METHOD, APPARATUS, DEVICE, MEDIUM AND PRODUCT”, and the entire content of each of these applications is incorporated by reference in this disclosure.

### TECHNICAL FIELD

The present disclosure relates to the field of computer technology, and specifically relates to an identity authentication method, apparatus, device, computer-readable storage medium, and computer program product.

### BACKGROUND

With the continuous development of computer technology, especially mobile Internet technology, office platforms have emerged. Enterprise users process work tasks through their internal office platforms, which can facilitate to process work tasks through collaboration, cooperation, etc., among users.

### SUMMARY

The purpose of the present disclosure is to provide an identity authentication method, apparatus, device, computer-readable storage medium and computer program product, which can simplify operations of users, thus improving the efficiency and experience of the users in processing work tasks.

In a first aspect, the present disclosure provides an identity authentication method, the method comprising:
acquiring a pre-configured first field of a first platform and a pre-configured second field of a second platform;
receiving a first field value of the first field sent by the first platform, the first field value being obtained after a first account passes identity authentication on the first platform;
determining a binding result of the first account according to the first field value; and
in response to that the binding result of the first account represents that there is a second field value in the second field that is bound with the first field value, passing identity authentication of a second account corresponding to the second field value.

In a second aspect, the present disclosure provides an identity authentication apparatus, comprising:
an acquisition module, configured to acquire a pre-configured first field of a first platform and a pre-configured second field of a second platform;
a receiving module, configured to receive a first field value of the first field sent by the first platform, the first field value being obtained after a first account passes identity authentication on the first platform; and
an authentication module, configured to determine a binding result of the first account according to the first field value; and in response to that the binding result of the first account represents that there is a second field value in the second field that is bound with the first field value, pass identity authentication of a second account corresponding to the second field value.

In a third aspect, the present disclosure provides a computer-readable medium having a computer program stored thereon, which, when executed by a processing apparatus, implements the steps of any of the methods in the first aspect of the present disclosure.

In a fourth aspect, the present disclosure provides an electronic device, comprising:
a storage apparatus having a computer program stored thereon;
a processing apparatus, configured to execute the computer program in the storage apparatus to implement the steps of any of the methods in the first aspect of the present disclosure.

In a fifth aspect, the present disclosure provides a computer program product comprising instructions, which, when run on a device, cause the device to execute the method in any of the implementations of the first or second aspect.

Other features and advantages of the present disclosure will be described in detail in the following detailed description.

### BRIEF DESCRIPTION OF THE DRAWINGS

The accompanying drawings, being used to provide a further understanding of the present invention and constituting a part of the specification, together with the embodiments of the present invention, are used to explain the present invention and do not constitute a limitation of the present invention. In the drawings:

FIG. 1 is a schematic diagram of a single sign-on scenario provided by an embodiment of the present disclosure;

FIG. 2 is a flow chart of an identity authentication method provided by an embodiment of the present disclosure;

FIG. 3 is a schematic diagram of a configuration page provided by an embodiment of the present disclosure;

FIG. 4 is a schematic diagram of an identity authentication apparatus provided by an embodiment of the present disclosure;

FIG. 5 is a schematic diagram of an electronic device provided in an embodiment of the present disclosure.

### DETAILED DESCRIPTION

The terms “first” and “second” in the embodiments of the present disclosure are used for descriptive purposes only and should not be understood as indicating or implying relative importance or implicitly indicating the number of the indicated technical features. Therefore, features defined with “first” and “second” may explicitly or implicitly include one or more of the features.

Generally, an internal office platform of an enterprise requires users to log in (authenticate) with their internal office platform accounts before they can process work tasks. However, in some cases, due to business needs, an enterprise user also need to log in to an external office platform of the enterprise. During the login process, the user needs to enter account number and password corresponding to the external office platform account again. The operation process for users is relatively cumbersome, which reduces the efficiency of the users in processing work tasks and the user experience is poor.

As it can be seen from the above technical solutions, the present disclosure has the following advantages:

The present disclosure provides an identity authentication method, the method comprising: acquiring a pre-configured first field of a first platform and a pre-configured second field of a second platform; receiving a first field value of the first field sent by the first platform, the first field value being obtained after a first account passes the identity authentication on the first platform; then, determining a binding result of the first account according to the first field value; in response to that the binding result of the first account represents that there is a second field value in the second field that is bound with the first field value, passing identity authentication of a second account corresponding to the second field value. In this way, a user only needs to enter account number and password corresponding to a first account, and after obtaining a returned first field value, a second account may be logged in on a second platform based on a binding relationship, without having to enter the account number and password for the second account again, which simplifies the operations required by the user during the login process and improves the efficiency and experience of the user in processing work tasks. Further, identity authentication based on the binding relationship can effectively reduce the risk of logging in to other people's accounts due to tampering with the first field value.

First, some technical terms involved in the embodiments of the present disclosure will be introduced.

Identity authentication refers to the process of confirming the identity of an operator (user) in an office platform, thereby determining whether the user has access to and permission to a certain resource, and further enabling access policy of the office platform to be implemented reliably and effectively, preventing attackers from impersonating legitimate users to gain access to resource, and ensuring the security of data on the office platform.

While in some cases, due to business needs, a user needs to log in not only to an internal office platform of an enterprise (for example, a first platform), but also to an external office platform of the enterprise (for example, a second platform). For security reasons, in response to that the user logs in to an account on the first platform, the user needs to enter account number and password of the account registered on the first platform for identity authentication. In response to that the user logs in to an account on the second platform, the user also needs to enter account number and password of the account registered on the second platform for identity authentication.

As it can be seen, in response to that the user logs in to different accounts on different platforms, the user needs to enter relevant account numbers and passwords multiple times. Thus, the operation process for the user is cumbersome and the user experience is poor.

In view of this, an embodiment of the present disclosure provides an identity authentication method, which may be executed by a second platform. Wherein, the second platform may be an office platform corresponding to a provider of an office system platform. Specifically, the method comprises: acquiring, by the second platform, a pre-configured first field of a first platform and a pre-configured second field of the second platform; then, receiving a first field value of the first field sent by the first platform, the first field value being obtained after a first account passes identity authentication on the first platform; next, determining a binding result of the first account according to the first field value; in response to that the binding result of the first account represents that there is a second field value in the second field that is bound with the first field value, passing identity authentication of a second account corresponding to the second field value. Therefore, the user only needs to enter the account number and password corresponding to the first account to log in to the second account on the second platform, without having to enter the password of the second account again, which simplifies the operations required by the user during the login process and improves the efficiency and experience of the user in processing work tasks.

To facilitate understanding, application scenarios of the identity authentication method provided by the embodiments of the present disclosure are first introduced below.

The technical solution of the present disclosure may be applied to scenarios such as integration platforms and integration services. At present, integration status quo commonly faced by enterprises includes: workflows are complex and business integrations are difficult; point-to-point docking and integration development costs between various systems are high and the cycle is long; a large amount of repetitive work in business integration is still handled manually; and the flow of business information and quantity is not smooth. Through the integration platform and integration service, application systems and integration frameworks can be integrated to form a complete platform, and then higher integration capabilities may be obtained at a lower cost, thereby solving the problems of high cost and low efficiency mentioned above. For example: realizing the transition from manual operation to comprehensive automated operation, from IT to the deep participation of various business roles in integration efficiency improvement, from main link customized solutions to standardized and visualized solutions, from high-cost configuration of long-tail links to flexible low-cost configuration, from meeting enterprise integration needs to achieving business innovation, etc.

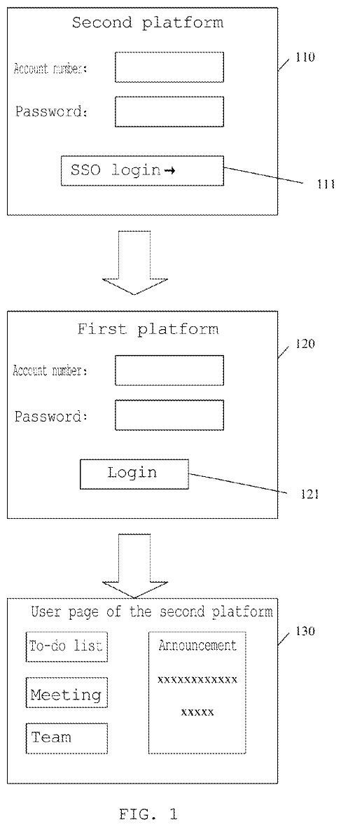

As shown in FIG. 1, it is a schematic diagram of a single sign-on scenario provided by an embodiment of the present disclosure. Relevant configuration of the single sign-on may be implemented through the above integrated platform or integrated service.

In this scenario, a user only needs to use an account for a first platform to log in to a second platform. As an example, the user may perform operation (for example, click, long press, etc.) on a single sign on (SSO) control 111 in a login page 110 of the second platform, then jumping to a login page 120 of an internal office platform of the enterprise (for example, the first platform) based on an enterprise identification entered by the user. The user enters account number and password of the internal account (for example, a first account) of the enterprise in the login page 120 of the first platform, and then clicks the login control 121. After receiving a login request for the first account, the first platform performs identity authentication on the first account. After the identity authentication of the first account is passed, a pre-configured first field value of a first field is sent to the second platform, and then the second platform first determines a binding result of the first account based on the first field value. In response to that the binding result of the first account represents that there is a second field value in the second field that is bound with the first field value, identity authentication of a second account corresponding to the second field value is passed, and then a user page 130 of the second platform is entered. Next, the user may process work tasks in the user page 130 of the second platform to meet business needs.

As it can be seen, in the above scenario, the user only needs to enter account number and password once to log in to the second account on the second platform using the first account of the platform, which simplifies operations of the user and improves the user experience.

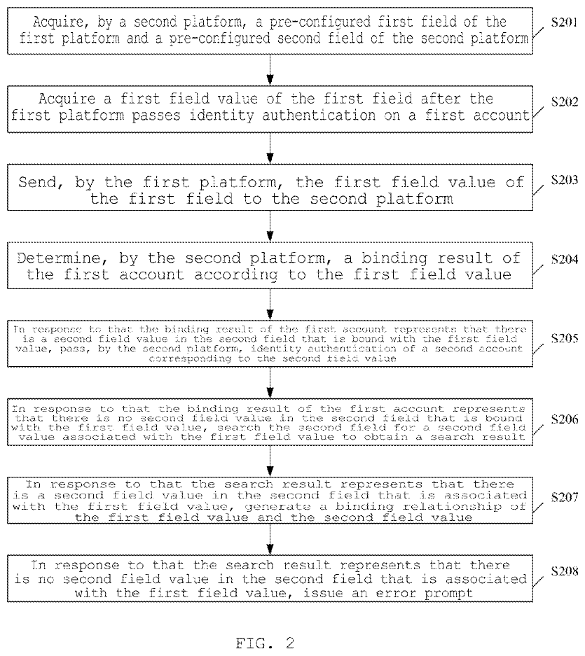

In order to make the technical solution of the present disclosure clearer and easier to understand, the identity authentication method provided by the embodiment of the present disclosure will be introduced below in conjunction with the accompanying drawings. As shown in FIG. 2, it is a flow chart of an identity authentication method provided by an embodiment of the present disclosure, the method comprising:

S201: acquiring, by a second platform, a pre-configured first field of a first platform and a pre-configured second field of the second platform.

As one optional example, the first platform refers to an internal office platform of an enterprise, and the second platform refers to an external office platform of the enterprise. The first field refers to an attribute in the first platform that can uniquely identify a first account in the first platform. For example, the first field may be an identity card number field, a mobile phone number field, a user identification (UID) field, etc. corresponding to the first account, where the UID may be assigned by the first platform after the first account is registered or enrolled on the first platform. Similarly, the second field refers to an attribute in the second platform that can uniquely identify the second account in the second platform. For example, the second field may be an identity card number field, a mobile phone number field, a user identification (UID) field, etc. corresponding to the second account, where the UID may be assigned by the second platform after the second account is registered or enrolled on the second platform.

In some examples, the first field of the first platform and the second field of the second platform may be pre-configured. As shown in FIG. 3, it is a schematic diagram of a configuration page provided by an embodiment of the present disclosure. As shown in FIG. 3, the configuration page includes a configuration control 310 for the first field of the first platform and a configuration control 320 for the second field of the second platform.

As one optional example, the user may perform operation (e.g., click) on the configuration control 310 for the first field, and then a drop-down box 311 of the first field will be presented. The drop-down box 311 of the first field includes a plurality of candidate fields 312, from which the user may select a field as the first field. Similarly, the user may perform operation on the configuration control 320 for the second field, and then a drop-down box 321 of the second field will be presented. The drop-down box of the second field includes a plurality of candidate fields 322, from which the user may select a field as the second field. In this way, after the user completes the pre-configuration of the first field and the second field, the second platform may save the pre-configured first field and the second field for subsequent processing such as association, etc., which will be introduced later.

S202: acquiring a first field value of the first field after the first platform passes identity authentication of a first account

The first account refers to an account registered or enrolled on the first platform. Continuing with the above example, the first platform is an internal office platform of an enterprise, and the first account is an account of a user of the enterprise. The first account can log in to the first platform so that the user of the enterprise may use the first platform to process work tasks. After the first account passes identity authentication on the first platform, the first platform acquires the first field value of the first field, which is used to uniquely identify the first account in the first platform.

After the first platform passes the identity authentication of the first account, the first field value of the first account is obtained. Continuing with the above example, the first field value refers to an attribute value of an attribute in the first platform that may uniquely identify the first account in the first platform, that is, the field value of the first field. As an example, the first field may be a UID field, and the first field value may be a UID, such as “123xxx123”. After the first platform passes the identity authentication of the first account, it obtains the UID of the first account.

Continuing to refer to FIG. 1, the user may perform operation on the single sign-on control 111 in the login page 110 of the second platform, then jumping to the login page 120 of the first platform. The user may enter account number and password of the first account in the login page 120 of the first platform, and then click the sign-on control. After the first platform passes the identity authentication of the first account, it obtains the first field value of the first account.

S203. sending, by the first platform, the first field value of the first field to the second platform.

After the first platform passes the identity authentication of the first account, the first platform may send the first field value of the first field to the second platform.

S204: determining, by the second platform, a binding result of the first account according to the first field value.

The binding result is used to represent whether there is a binding relationship between the first field value in the first field and the second field value in the second field. In some examples, the binding relationship is shown in Table 1 below:

TABLE 1

| First field | Second field |
|---|---|
| Field 11 | Field 12 |
| Field 21 | Field 22 |
| . . . | . . . |

Wherein, “Field 11” and “Field 21” are field values of the first field (i.e., the first field value), and “Field 12” and “Field 22” are field values of the second field (i.e., the second field value). There is a binding relationship of “Field 11” and “Field 12”, and there is a binding relationship of “Field 21” and “Field 22”.

After determining the first field value, the second platform may determine the binding result of the first account based on Table 1. Taking the first field value being “Field 11” as an example, the second platform may determine the binding result of the first account based on the “Field 11” and above Table 1. As it may be seen from above Table 1, there is a binding relationship of “Field 11” and “Field 12”, and thus the binding result that there is “Field 12” in the second field that is bound with the “Field 11” may be obtained. Similarly, taking the first field value being “31” as an example, the second platform determines the binding result of the first account based on the “Field 31” and Table 1 above. As it may be seen from above Table 1, the “Field 31” is not in above Table 1, and thus the binding result that there is no field value in the second field that is bound with the “Field 31” may be obtained.

In some embodiments, a set of binding relationships may be saved on the second platform. After receiving the first field value sent by the first platform, the second platform may search for a binding relationship corresponding to the first field value in the set of binding relationships based on the first field value.

In response to that the second platform can find a binding relationship corresponding to the first field value from the set of binding relationships based on the first field value, a binding result that there is a second field value in the second field that is bound with the first field value is obtained; in response to that the second platform cannot find a binding relationship corresponding to the first field value from the set of binding relationships based on the first field value, a binding result that there is no second field value in the second field that is bound with the first field value is obtained. Wherein binding relationships of field values in the first field and field values in the second field may be seen in Table 1 above, which will not be repeated here.

In some embodiments, binding relationships in the set of binding relationships above may be obtained by pre-configuration. That is, the binding relationship of the first field value and the second field value is pre-configured, and binding relationships in the above set of binding relationships may also be generated in response to that the second platform first finds the second field value associated with the first field value in the second field, that is, the binding relationship of the first field value and the second field value is generated. In other embodiments, the binding relationships in the set of binding relationships may also be obtained by a combination of the above two ways. The implementation for generating the binding relationship of the first field value and the second field value will be introduced later.

S205. in response to that the binding result of the first account represents that there is a second field value in the second field that is bound with the first field value, passing, by the second platform, identity authentication of a second account corresponding to the second field value.

In response to that the binding result of the first account represents that there is a second field value in the second field that is bound with the first field value, it indicates that there is an account in the second platform that is bound with the first account in the first platform. Then, the second platform may determine the second account based on the second field value that has a binding relationship with the first field value.

Wherein, the second field value may uniquely identify the second account in the second platform. In some examples, after the second account is registered or enrolled on the second platform, the correspondence between the second account and the second field value may be saved in the second platform, and then the second platform may determine the second account corresponding to the second field value from the correspondence. In turn, the second platform passes identity authentication of the second account corresponding to the second field value. Continuing to refer to FIG. 1, after the second platform passes the identity authentication of the second account, it enters the user page 130 of the second platform, and the user may process work tasks in the user page 130 of the second platform to meet business needs.

In the embodiment of the present disclosure, therefore, the user only needs to enter the account number and password corresponding to the first account in the first platform to log in to the second account on the second platform without having to enter the account number and password of the second account again, which simplifies the operations required by the user during the login process and improves the efficiency and experience of the user in processing work tasks.

S206. in response to that the binding result of the first account represents that there is no second field value in the second field that is bound with the first field value, searching a second field for the second field value associated with the first field value to obtain a search result.

In response to that the binding result of the first account represents that there is no second field value in the second field that is bound with the first field value, it indicates that there is no account in the second platform that is bound with the first account in the first platform. At this time, the second platform may search the second field for the second field value associated with the first field value to obtain a search result.

Wherein, the search result is used to represent whether there is an association relationship of a first field value in the first field and a second field value in the second field. In some examples, there being an association relationship of a first field value and a second field value may mean that the first field value is consistent with the second field value. In other examples, there being an association relationship of a first field value and a second field value may mean that the first field value becomes the second field value after a preset transformation.

Based on this, the second platform may determine a binding rule, and then bind unbound field values in the first field and the second field based on the binding rule. The binding rule may be that in response to that a field value in the first field is consistent with a field value in the second field, then a binding is performed; the binding rule may also be that in response to that a field value in the first field become a field value in the second field after a preset transformation, then a binding is performed. It may be understood that the embodiments of the present disclosure do not have limitation on the binding rule.

S207: in response to that the search result represents that there is a second field value in the second field that is associated with the first field value, generating a binding relationship of the first field value and the second field value.

In response to that the search result represents that there is a second field value in the second field that is associated with the first field value, it indicates that there is an account in the second platform that is associated with the first account in the first platform. Then, the first field value and the second field value may be bound on the second platform, that is, a binding relationship of the first field value and the second field value is generated.

In some embodiments, after determining the second field value associated with the first field value, the second platform may process the first field value based on a preset algorithm to obtain a processed first field value. The preset algorithm may be an algorithm for changing characters in the first field value according to a preset rule, for example, it may be circularly shifting characters in the first field value to the right by a preset number of digits to obtain a processed first field value.

Taking a first field value being “123456” as an example, after the first field value is processed by a preset algorithm, which may circularly shift characters of the first field value to the right by 2 bits, a processed first field value of “561234” is then obtained. Then, the second platform binds the processed first field value with the second field value to generate a binding relationship between the processed first field value and the second field value, thereby further increasing the security of the binding relationship.

After the second platform generates the above binding relationship of the first field value and the second field value, the binding relationship may be stored in the above set of binding relationships for use in subsequent login processes. In this way, in response to that a user performs a single sign-on process subsequently, the second platform may determine the second field value that is bound with the first field value of the first account based on the above binding relationship, and then determine a second account corresponding to the second field value based on the second field value, and then pass identity authentication of the second account.

S208. in response to that the search result represents that there is no second field value in the second field that is associated with the first field value, issuing an error prompt.

In response to that the search result represents that there is no second field value in the second field that is associated with the first field value, it indicates that there is no account in the second platform that is associated with the first account in the first platform, and then the second platform may issue an error prompt. For example, it may be a prompt that the user cannot log in to the second platform with the current first account and needs to register or enroll a second account with the second platform.

In the identity authentication method provided in an embodiment of the present disclosure, the second platform first perform identity authentication on a single sign-on account based on a binding relationship. Only in response to that the binding relationship of the account (the binding relationship of the first field value and the second field value) is not saved in the second platform, the account for the single sign-on is performed identity authentication by way of association, which can improve the security of single sign-on. In response to that the account for the single sign-on is performed identity authentication only by way of association, since the second platform completely trusts the field value of the first field fed back by the first platform, in response to that the field value is maliciously tampered with, the second platform will perform identity authentication on corresponding account with the tampered field value, which has poor security. While the embodiment of the present disclosure first performs identity authentication based on the binding relationship, which may improve the security of single sign-on.

It should be noted that the above steps S206-S208 are optional. In some embodiments, the above steps S206-S208 may not be performed.

Based on the above description, an embodiment of the present disclosure provides an identity authentication method, the method comprising: acquiring a pre-configured first field of a first platform and a pre-configured second field of a second platform; receiving a first field value of the first field sent by the first platform, the first field value being obtained after a first account passes the identity authentication on the first platform; then, determining a binding result of the first account according to the first field value; in response to that the binding result of the first account represents that there is a second field value in the second field that is bound with the first field value, passing identity authentication of a second account corresponding to the second field value. In this way, a user only needs to enter account number and password corresponding to a first account to log in to a second account on a second platform, without having to enter the account number and password for the second account again, which simplifies the operations required by the user during the login process and improves the efficiency and experience of the user in processing work tasks.

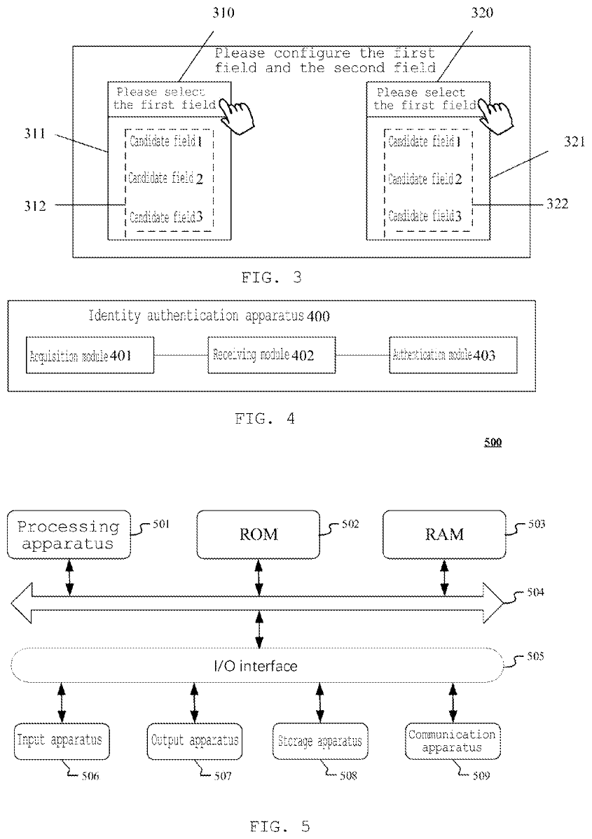

FIG. 4 is a schematic diagram of an identity authentication apparatus according to an exemplary embodiment of the present disclosure. As shown in FIG. 4, the identity authentication apparatus 400 comprises:
an acquisition module 401, configured to acquire a pre-configured first field of a first platform and a pre-configured second field of a second platform;
a receiving module 402, configured to receive a first field value of a first field sent by the first platform, the first field value being obtained after a first account passes identity authentication on the first platform;
an authentication module 403, configured to determine a binding result of the first account according to the first field value; and in response to that the binding result of the first account represents that there is a second field value in the second field that is bound with the first field value, pass identity authentication of a second account corresponding to the second field value.

Optionally, the identity authentication apparatus 400 further comprises: a binding module;

The binding module is configured to search the second field for a second field value associated with the first field value to obtain a search result in response to that the binding result of the first account represents that there is no second field value in the second field that is bound with the first field value; and to generate a binding relationship of the first field value and the second field value in response to that the search result represents that there is a second field value in the second field that is associated with the first field value.

Optionally, the identity authentication apparatus 400 further comprises: a prompt module;

The prompt module is configured to issue an error prompt in response to that the search result represents that there is no second field value in the second field that is associated with the first field value.

The authentication module 403 is specifically configured to, in response to that a binding relationship corresponding to the first field value is found from a set of binding relationships according to the first field value, obtain a binding result that there is a second field value in the second field that is bound with the first field value; and, in response to that a binding relationship corresponding to the first field value is not found from the set of binding relationships according to the first field value, obtain a binding result that there is no second field value in the second field that is bound with the first field value.

Optionally, binding relationships in the set of binding relationships are obtained by:
pre-configuring a binding relationship of the first field value and the second field value; and/or,
in response to that a second field value in the second field that is associated with the first field value is found for the first time, generating a binding relationship of the first field value and the second field value.

Optionally, the first field value being associated with the second field value comprises:
the first field value being consistent with the second field value; or,
the first field value becoming the second field value after a preset transformation.

Optionally, the first field value is used to uniquely identify the first account in the first platform, and the second field value is used to uniquely identify the second account in the second platform.

The functions of the above modules have been described in detail in the method steps in the previous embodiments, which will not be repeated here.

Referring to FIG. 5, it shows a schematic structural diagram of an electronic device 500 suitable for implementing the embodiment of the present disclosure, and the electronic device is used to implement the functions corresponding to the identity authentication apparatus 400 shown in FIG. 4. The electronic device shown in FIG. 5 is only one example and should not bring any limitation to the functions and scope of use of the embodiments of the present disclosure.

As shown in FIG. 5, the electronic device 500 may include a processing apparatus (e.g., a central processing unit, a graphics processing unit, etc.) 501, which may perform various appropriate actions and processes according to a program stored in a read-only memory (ROM) 502 or a program loaded from a storage apparatus 508 into a random access memory (RAM) 503. In the RAM 503, various programs and data required for the operation of the electronic device 500 are also stored. The processing apparatus 501, the ROM 502, and the RAM 503 are connected to each other via a bus 504. An input/output (I/O) interface 505 is also connected to the bus 504.

Generally, the following apparatus may be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage apparatus 508 including, for example, a magnetic tape, a hard disk, etc.; and a communication apparatus 509. The communication apparatus 509 may allow the electronic device 500 to perform wireless or wired communication with other devices to exchange data. Although FIG. 5 shows an electronic device 500 having various apparatus, it should be understood that it is not required to implement or have all of the illustrated apparatus. More or fewer apparatus may be implemented or provided alternatively.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, and the computer program contains program code for executing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus or device. In the present disclosure, a computer-readable signal medium may include a data signal propagated in a baseband or as a part of a carrier wave, which carries computer-readable program code. This propagated data signal may take a variety of forms, including but not limited to electromagnetic signals, optical signals, or any suitable combination thereof. The computer-readable signal medium may also be any computer-readable medium other than computer-readable storage medium, which may send, propagate or transmit a program for use by or in conjunction with an instruction execution system, apparatus or device. The program code contained on the computer-readable medium may be transmitted by any appropriate medium, including but not limited to: wire, optical cable, RF (radio frequency), etc., or any suitable combination thereof.

In some embodiments, the client and server may communicate using any currently known or future developed network protocol such as HTTP (HyperText Transfer Protocol), and may be interconnected with any form or medium of digital data communication (e.g., a communication network). Examples of a communication network include a local area network (“LAN”), a wide area network (“WAN”), an international network (e.g., the Internet), and a peer-to-peer network (e.g., an ad hoc peer-to-peer network), as well as any currently known or future developed network.

The above computer-readable medium may be included in the above electronic device, or may exist independently without being assembled into the electronic device.

The above computer-readable medium carries one or more programs, which, when executed by the electronic device, cause the electronic device to: acquire a pre-configured first field of a first platform and a pre-configured second field of a second platform; receives a first field value of the first field sent by the first platform, the first field value being obtained after a first account passes identity authentication on the first platform; determines a binding result of the first account according to the first field value; and in response to that the binding result of the first account represents that there is a second field value in the second field that is bound with the first field value, passes identity authentication of a second account corresponding to the second field value.

The computer program code for performing the operations of the present disclosure may be written in one or more programming languages or a combination thereof, including, but not limited to, object-oriented programming languages, such as Java, Smalltalk, C++, and conventional procedural programming languages, such as “C” language or similar programming languages. The program code may be executed entirely on a user's computer, partially on the user's computer, as a separate software package, partially on the user's computer and partially on a remote computer, or entirely on a remote computer or server. In the case of a remote computer involved, the remote computer may be connected to the user's computer through any kind of network, including a local area network (LAN) or a wide area network (WAN), or may be connected to an external computer (e.g., connected by using Internet provided by an Internet service provider).

The flow charts and block diagrams in the accompanying drawings illustrate possible architecture, function and operation implementations of the system, method and computer program product according to various embodiments of the present disclosure. In this regard, each block in a flow chart or block diagram may represent a module, a program segment or a part of code, which contains one or more executable instructions for realizing specified logical functions. It should also be noted that, in some alternative implementations, functions marked in a block may also occur in a different order than the order marked in the drawings. For example, two blocks shown in succession may actually be executed substantially in parallel, and they may sometimes be executed in the reverse order, depending on functions involved. It should also be noted that each block in a block diagram and/or flowchart, and the combination of blocks in a block diagram and/or flowchart, may be implemented by a dedicated hardware-based system that performs the specified functions or operations, or it may be implemented by a combination of dedicated hardware and computer instructions.

The modules involved in the embodiments of the present disclosure may be implemented in software or hardware. Wherein, the name of a module does not constitute a limitation on the module itself under certain circumstances, for example, a first acquisition module may also be described as a “a module for acquiring at least two Internet Protocol addresses”.

The functions described herein above may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides an identity authentication method, comprising:
acquiring a pre-configured first field of a first platform and a pre-configured second field of a second platform;
receiving a first field value of the first field sent by the first platform, the first field value being obtained after a first account passes identity authentication on the first platform;
determining a binding result of the first account according to the first field value; and
in response to that the binding result of the first account represents that there is a second field value in the second field that is bound with the first field value, passing identity authentication of a second account corresponding to the second field value.

According to one or more embodiments of the present disclosure, Example 2 provides the method of Example 1, wherein the method further comprises:
in response to that the binding result of the first account represents that there is no second field value in the second field that is bound with the first field value, searching the second field for a second field value associated with the first field value to obtain a search result; and
in response to that the search result represents that there is a second field value in the second field that is associated with the first field value, generating a binding relationship of the first field value and the second field value.

According to one or more embodiments of the present disclosure, Example 3 provides the method of Example 2, wherein the method further comprises:
in response to that the search result represents that there is no second field value in the second field that is associated with the first field value, issuing an error prompt.

According to one or more embodiments of the present disclosure, Example 4 provides the methods of Examples 1 to 3, the determining a binding result of the first account according to the first field value comprises:
in response to that a binding relationship corresponding to the first field value is found from a set of binding relationships according to the first field value, obtaining a binding result that there is a second field value in the second field that is bound with the first field value; and
in response to that a binding relationship corresponding to the first field value is not found from the set of binding relationships according to the first field value, obtaining a binding result that there is no second field value in the second field that is bound with the first field value.

According to one or more embodiments of the present disclosure, Example 5 provides the method of Example 4, wherein binding relationships in the set of binding relationships are obtained by:
pre-configuring a binding relationship of the first field value and the second field value; and/or,
in response to that a second field value in the second field that is associated with the first field value is found for the first time, generating a binding relationship of the first field value and the second field value.

According to one or more embodiments of the present disclosure, Example 6 provides the method of Example 2, wherein the first field value being associated with the second field value comprises:
the first field value being consistent with the second field value; or,
the first field value becoming the second field value after a preset transformation.

According to one or more embodiments of the present disclosure, Example 7 provides the method of Example 1, wherein the first field value is used to uniquely identify the first account in the first platform, and the second field value is used to uniquely identify the second account in the second platform.

The above description is only preferred embodiments of the present disclosure and an explanation of the technical principles applied. Those skilled in the art should understand that the scope of disclosure involved in the present disclosure is not limited to the technical solutions formed by a specific combination of the above technical features, but should also cover other technical solutions formed by any combination of the above technical features or equivalent features thereof without departing from the above disclosed concept. For example, those technical solutions formed by exchanging of above features and technical features disclosed in the present disclosure (but not limited to) having similar functions with each other.

In addition, although various operations are described in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or method logic actions, it should be understood that the subject matter defined in the appended claims is not necessarily limited to the specific features or actions described above. Rather, the specific features and actions described above are merely example forms of implementing the claims. Regarding the apparatus in the above embodiments, the specific manner in which each module performs operations has been described in detail in the method embodiments, which will not be elaborated here.

1. An identity authentication method, comprising:
acquiring a pre-configured first field of a first platform and a pre-configured second field of a second platform;
receiving a first field value of the first field sent by the first platform, the first field value being obtained after a first account passes identity authentication on the first platform;
determining a binding result of the first account according to the first field value; and
in response to that the binding result of the first account represents that there is a second field value in the second field bound with the first field value, passing identity authentication of a second account corresponding to the second field value.

2. The method according to claim 1, wherein the method further comprises:
in response to that the binding result of the first account represents that there is no second field value in the second field bound with the first field value, searching the second field for a second field value associated with the first field value to obtain a search result; and
in response to that the search result represents that there is a second field value in the second field that is associated with the first field value, generating a binding relationship of the first field value and the second field value.

3. The method according to claim 2, wherein the method further comprises:
in response to that the search result represents that there is no second field value in the second field associated with the first field value, issuing an error prompt.

4. The method according to claim 1, wherein the determining a binding result of the first account according to the first field value comprises:
in response to that a binding relationship corresponding to the first field value is found from a set of binding relationships according to the first field value, obtaining a binding result that there is a second field value in the second field that is bound with the first field value; and
in response to that a binding relationship corresponding to the first field value is not found from the set of binding relationships according to the first field value, obtaining a binding result that there is no second field value in the second field that is bound with the first field value.

5. The method according to claim 4, wherein binding relationships in the set of binding relationships are obtained by at least one of:
pre-configuring a binding relationship of the first field value and the second field value; or,
in response to that a second field value in the second field that is associated with the first field value is found for the first time, generating a binding relationship of the first field value and the second field value.

6. The method according to claim 2, wherein the first field value being associated with the second field value comprises:
the first field value being consistent with the second field value; or,
the first field value becoming the second field value after a preset transformation.

7. The method according to claim 1, wherein the first field value is used to uniquely identify the first account in the first platform, and the second field value is used to uniquely identify the second account in the second platform.

8. (canceled)

9. An electronic device, comprising:
a storage apparatus having a computer program stored thereon;
a processing apparatus, configured to execute the computer program in the storage apparatus to implement the steps of the method according to an identity authentication method, the method comprising:
acquiring a pre-configured first field of a first platform and a pre-configured second field of a second platform;
receiving a first field value of the first field sent by the first platform, the first field value being obtained after a first account passes identity authentication on the first platform;
determining a binding result of the first account according to the first field value; and
in response to that the binding result of the first account represents that there is a second field value in the second field that is bound with the first field value, passing identity authentication of a second account corresponding to the second field value.

10. A non-transitory computer-readable storage medium having a computer program stored thereon, when executed by a processing apparatus, the program implements the steps of the method according to an identity authentication method, the method comprising:
acquiring a pre-configured first field of a first platform and a pre-configured second field of a second platform;
receiving a first field value of the first field sent by the first platform, the first field value being obtained after a first account passes identity authentication on the first platform;
determining a binding result of the first account according to the first field value; and
in response to that the binding result of the first account represents that there is a second field value in the second field that is bound with the first field value, passing identity authentication of a second account corresponding to the second field value.

11. (canceled)

12. The medium according to claim 10, wherein the method further comprises:
in response to that the binding result of the first account represents that there is no second field value in the second field that is bound with the first field value, searching the second field for a second field value associated with the first field value to obtain a search result; and
in response to that the search result represents that there is a second field value in the second field that is associated with the first field value, generating a binding relationship of the first field value and the second field value.

13. The medium according to claim 12, wherein in the method further comprises:
in response to that the search result represents that there is no second field value in the second field that is associated with the first field value, issuing an error prompt.

14. The medium according to claim 10, wherein the determining a binding result of the first account according to the first field value comprises:
in response to that a binding relationship corresponding to the first field value is found from a set of binding relationships according to the first field value, obtaining a binding result that there is a second field value in the second field that is bound with the first field value; and
in response to that a binding relationship corresponding to the first field value is not found from the set of binding relationships according to the first field value, obtaining a binding result that there is no second field value in the second field that is bound with the first field value.

15. The medium according to claim 14, wherein binding relationships in the set of binding relationships are obtained by at least one of:
pre-configuring a binding relationship of the first field value and the second field value; or,
in response to that a second field value in the second field that is associated with the first field value is found for the first time, generating a binding relationship of the first field value and the second field value.

16. The medium according to claim 12, wherein the first field value being associated with the second field value comprises:
the first field value being consistent with the second field value; or,
the first field value becoming the second field value after a preset transformation.

17. The medium according to claim 10, wherein the first field value is used to uniquely identify the first account in the first platform, and the second field value is used to uniquely identify the second account in the second platform.

18. The device according to claim 9, wherein the method further comprises:
in response to that the binding result of the first account represents that there is no second field value in the second field that is bound with the first field value, searching the second field for a second field value associated with the first field value to obtain a search result; and
in response to that the search result represents that there is a second field value in the second field that is associated with the first field value, generating a binding relationship of the first field value and the second field value.

19. The device according to claim 18, wherein in the method further comprises:
in response to that the search result represents that there is no second field value in the second field that is associated with the first field value, issuing an error prompt.

20. The device according to claim 9, wherein the determining a binding result of the first account according to the first field value comprises:
in response to that a binding relationship corresponding to the first field value is found from a set of binding relationships according to the first field value, obtaining a binding result that there is a second field value in the second field that is bound with the first field value; and
in response to that a binding relationship corresponding to the first field value is not found from the set of binding relationships according to the first field value, obtaining a binding result that there is no second field value in the second field that is bound with the first field value.

21. The device according to claim 20, wherein binding relationships in the set of binding relationships are obtained by at least one of:
pre-configuring a binding relationship of the first field value and the second field value; or,
in response to that a second field value in the second field that is associated with the first field value is found for the first time, generating a binding relationship of the first field value and the second field value.

22. The device according to claim 18, wherein the first field value being associated with the second field value comprises:
the first field value being consistent with the second field value; or,
the first field value becoming the second field value after a preset transformation.
sending the service order to a first client corresponding to the first user.
